(19) United States
(12) Patent Application Publication
(10) Pub. No.: US 2016/0253643 A1
(43) Pub. Date: Sep. 1, 2016

(54) METHOD OF COMPLETING A PURCHASE TRANSACTION

(71) Applicant: NCR Corporation, Duluth, GA (US)

(72) Inventor: Richard Hugh Damion Rhodd, Loganville, GA (US)

(21) Appl. No.: 14/672,593

(22) Filed: Mar. 30, 2015

Related U.S. Application Data
(60) Provisional application No. 62/121,882, filed on Feb. 27, 2015.

(51) Int. Cl. G06Q 20/16; G06Q 20/40; H04L 29/06; G06Q 20/10

(52) U.S. Cl. CPC G06Q 20/16; G06Q 20/108; G06Q 20/405; G06Q 20/4012; H04L 65/1059

(57) ABSTRACT

A method of completing a purchase transaction in which a customer may conduct a video conferencing session with a financial institution to facilitate payment. In one example embodiment, the method includes attempting by a transaction terminal to complete a payment through a payment authorization system, receiving by the transaction terminal a notification from the payment authorization system of a problem resulting in the payment not being completed, establishing by the transaction terminal a video conferencing session with the representative of a financial system of a financial institution associated with the customer to correct the problem, and completing by the transaction terminal the payment through the payment authorization system in accordance with an outcome of the video conferencing session.

### BACKGROUND

The present invention relates to point of sale systems and methods, and more specifically to a method of completing a purchase transaction.

During a purchase transaction, a customer may be unable to complete payment for goods or services using a payment card for various reasons. For example, the amount of a purchase transaction may result in the customer's credit or debit limit being exceeded for a single transaction. As another example, another company may have placed a block or hold on the customer's payment card to ensure adequate funds are available. Under such circumstances, the customer must look to alternative payment methods.

It would be desirable to provide a method of completing payment which overcomes these problems.

### SUMMARY

In accordance with the teachings of the present invention, a method of completing a purchase transaction is provided.

In one example embodiment, the method includes attempting by a transaction terminal to complete a payment through a payment authorization system, receiving by the transaction terminal a notification from the payment authorization system of a problem resulting in the payment not being completed, establishing by the transaction terminal a video conferencing session with the representative of a financial system of a financial institution associated with the customer to correct the problem, and completing by the transaction terminal the payment through the payment authorization system in accordance with an outcome of the video conferencing session.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of an example payment system;

FIG. 2 is a block diagram of an example transaction terminal; and

FIGS. 3A-3B form a flow diagram of an example method of completing a purchase transaction.

### DETAILED DESCRIPTION

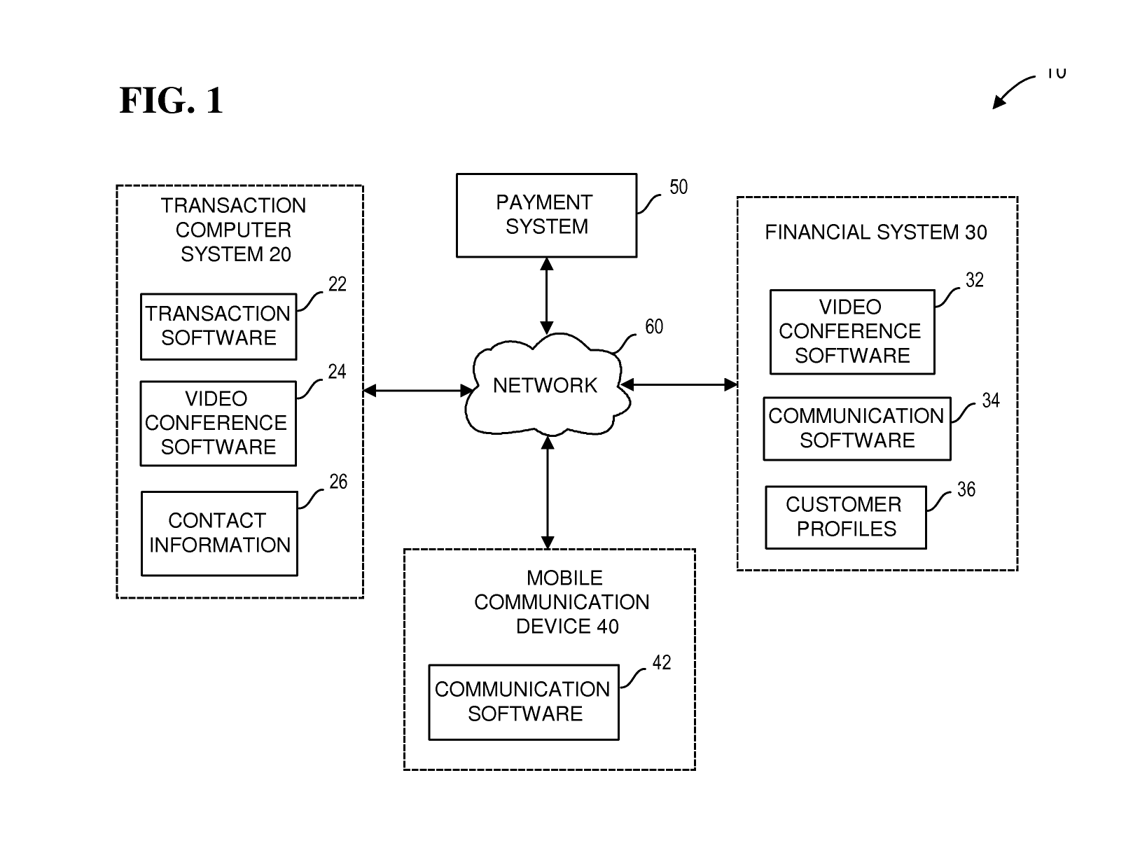

With reference to FIG. 1, an example payment system 10 includes transaction computer system 20, one or more financial systems 40, mobile communication device 40, and payment authorization system 50, all connected via network 60.

Transaction computer system 20 may include one or more processors, memory, and program storage. Transaction computer system 20 may execute an operating system such as a Microsoft, Linux, Google, or Apple operating system.

Transaction computer system 20 may include a self-service checkout system or an assisted-service checkout system.

Transaction computer system 20 may execute software which is stored in a computer readable medium, such as a memory. For example, transaction computer system 20 may execute web browser software.

Transaction computer system 20 also executes transaction software 22, which records items for purchase and processes payment for the items. Transaction software 22 may be a web application that is executed using web browser software.

Transaction computer system 20 also executes video conference software 24 for establishing a video conferencing session with a financial system 30 of the customer when a customer requires assistance to complete a payment during a transaction.

A customer may be unable to complete payment for goods or services using a payment card for various reasons. For example, the amount of a purchase transaction may result in the customer's credit or debit limit being exceeded for a single transaction. As another example, another company may have placed a block or hold on the customer's payment card due to ensure adequate funds are available.

In one example embodiment, video conference software 24 may include a plug-in software component executed within web browser software and controlled by transaction software 22.

In another example embodiment, video conference software 24 is a stand-alone application.

In one example embodiment, video conference software 24 may obtain contact information for establishing a video conferencing session from contact information 26. Transaction system 20 may maintain contact information 26 for local or major banks, either locally or on an in-store server.

In another example embodiment, video conference software 24 may obtain contact information for establishing a video conferencing session from a customer.

Financial system 30 may include one or more processors, memory, and program storage. Financial system 30 may execute an operating system such as a Microsoft, Linux, Google, or Apple operating system. Financial system 30 may execute software which is stored in a computer readable medium, such as a memory. For example, financial system 30 may execute web browser software.

Financial system 30 also executes video conference software 42, which interacts with video conference software 24 during a video conferencing session.

In one example embodiment, video conference software 42 may include a plug-in software component executed within web browser software to open a video conferencing session within the web browser window or in a new window.

In another example embodiment, video conference software 42 is a stand-alone application that opens a video conferencing session in a new window.

Financial system 30 may require some form of authentication to ensure that the customer is not a thief or imposter.

In one example embodiment, financial system 30 may execute communication software 34, which sends a message to customer mobile communication device 40 using customer contact information in customer profiles 36. The message may be sent

The message may include a text or email message that mobile communication device 40 receives and displays using communication software 42. The message may contain a code that the customer must enter into transaction system 20 in order to continue with the video conferencing session.

In another example embodiment, the message may require the customer to reply to the message by taking and sending a self-image using a camera of mobile communication device 40.

For debit card transactions, customer entry of a PIN may also serve to authenticate the customer, alone or in combination with other authentication procedures.

During the video conferencing session, a representative of financial system 30 may determine and approve a solution for completing payment, or not, depending upon the customer and the circumstances.

For example, if the customer's credit or debit limit would be exceeded for a single transaction, the representative may choose to increase the customer's credit limit.

As another example, if a block or hold has been placed on the customer's debit card to ensure adequate funds are available, the representative may suggest a short-term loan. The customer and the representative may complete the load procedures during the video conferencing session.

Financial system 30 updates a customer bank record when credit has been authorized following a video conferencing session.

Mobile communication device 40 may include one or more processors, memory, and program storage. Mobile communication device 40 may execute an operating system such as a Microsoft, Linux, Google, or Apple operating system. Mobile communication device 40 may execute software which is stored in a computer readable medium, such as a memory.

Payment authorization system 50 performs authorization and settlement functions when a customer chooses to pay with a payment card, such as a credit or debit card. Payment authorization system 50 may be a merchant acquirer or processor. Payment authorization system 50 receives a request from transaction computer system 20 containing payment card information, including but not limited to the payment card number, the card expiration date, the amount of the order, and the PIN, if the payment card is a debit card. Payment authorization system 50 sends the payment card information to a financial system 30 that issued the payment card, which may include a bank or a credit card association.

The financial system 30 that issued the payment card validates the card number and expiration and checks the amount of the order against an available credit limit. Financial system 30 then either authorizes or denies the payment and sends a corresponding response to payment authorization system 50, which then forwards the response to transaction system 20.

Network 60 may include one which uses the transmission control protocol/internet protocol (TCP/IP). Network 60 may include a combination of local area and wide area networks. Network 60 may include any combination of wireless or wired networks. Network 60 may include a combination of private and public networks, including a global communication network, also known as the Internet. Network may include any combination of wireless technologies, including Wi-Fi, Bluetooth and/or near field communication (NFC) standard circuitry

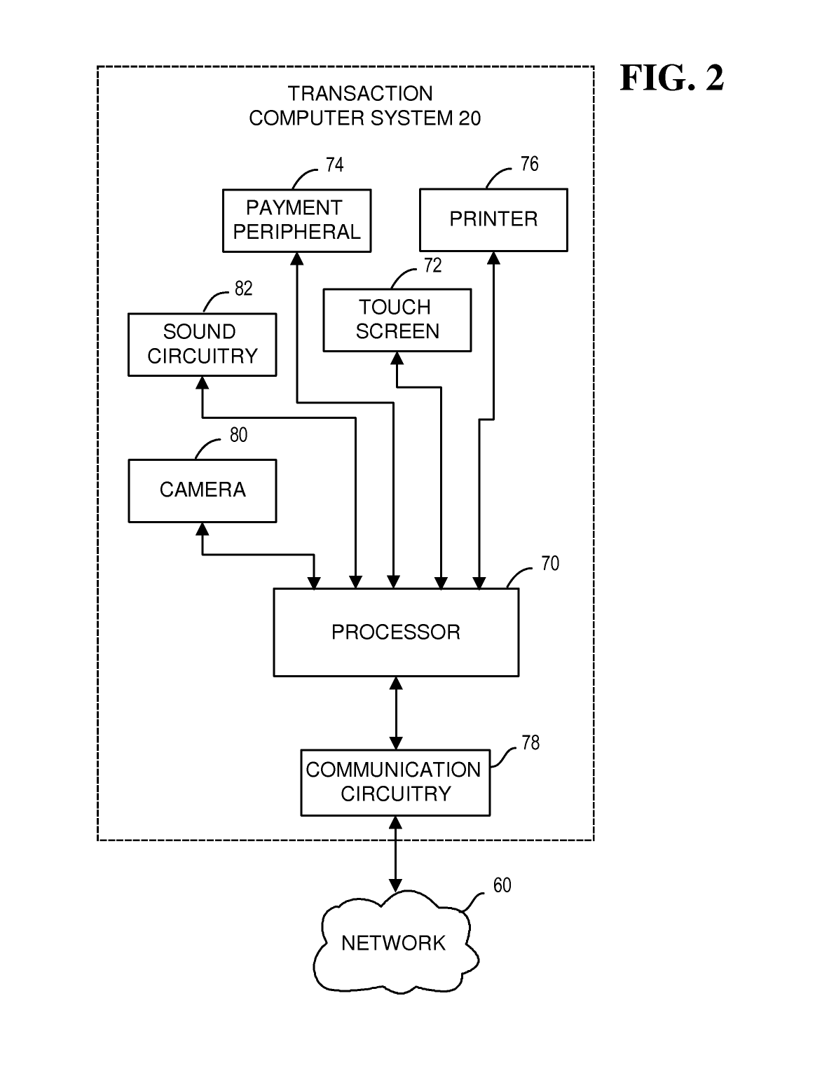

Referring now to FIG. 2, an example transaction computer system 20 includes processor 70, touch screen 72, payment peripheral 74, printer 76, and communication circuitry 78.

Processor 70 executes transaction software 22 and video conference software 24.

Touch screen 72 displays transaction screens from transaction software 22 and captures operator inputs and selections during a transaction.

In one example embodiment, video conferencing occurs on touch screen 72.

In another example embodiment, video conferencing occurs on secondary or customer display coupled to processor 60.

Payment peripheral 74 captures payment information, and may include a card reader, personal identification number (PIN) keypad, signature capture pad, or other peripheral used to accomplish payment, or any combination of such peripherals.

Printer 76 prints documents such as receipts and coupons during a transaction.

Communication circuitry 78 may include wired or wireless networking circuitry, Bluetooth and/or NFC standard circuitry.

To facilitate video conferencing sessions, example transaction computer system 20 also includes camera 80 and sound circuitry 82. Camera 80 captures digital video images during a video conferencing session. Sound circuitry 82 captures and produces sounds during a video conferencing session. Sound circuitry 82 includes a microphone and speakers.

In one example embodiment, touch screen 72 includes a surrounding bezel and the camera and microphone are located in the bezel.

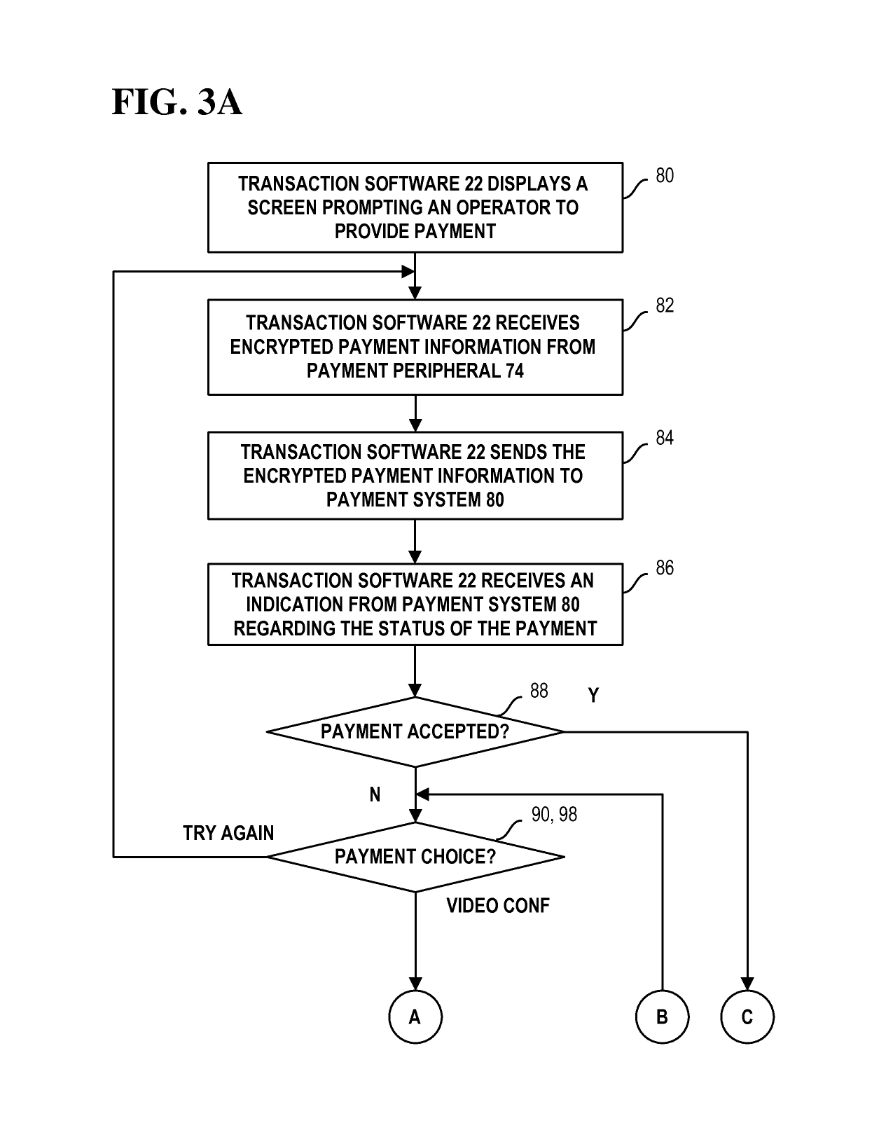

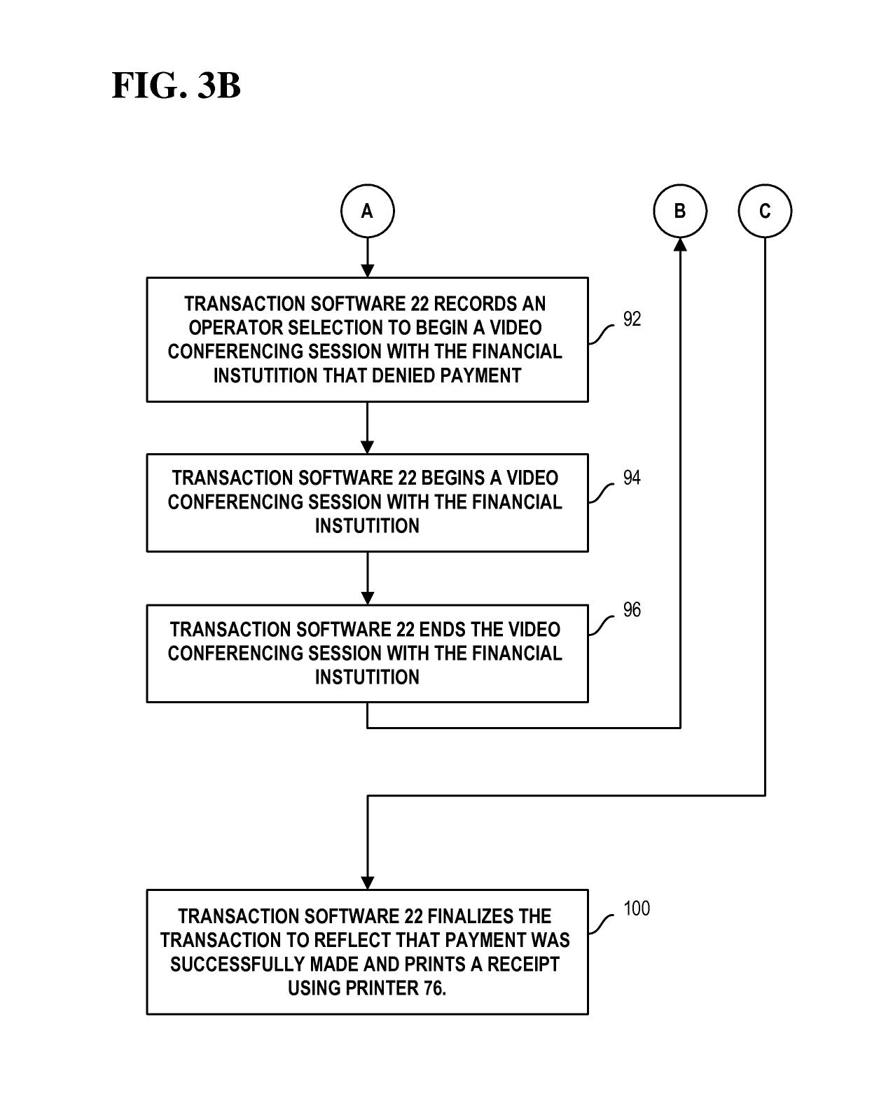

Referring now to FIG. 3, an example transaction method begins with step 80.

In step 80, transaction software 22 displays a screen prompting an operator to provide payment.

The customer uses payment peripheral 74 to capture payment information from a customer payment card.

In one example embodiment, the customer uses a card reader to capture payment information from a credit card.

In another one example embodiment, the customer uses a card reader to capture payment information from a debit card and uses a PIN keypad to enter a PIN.

In step 82, transaction software 22 receives encrypted payment information from payment peripheral 74.

In step 84, transaction software 22 sends the encrypted payment information to payment authorization system 50.

In step 86, transaction software 22 receives an indication from payment authorization system 50 regarding the status of the payment.

For example, transaction software 22 may receive a communication from payment authorization system 50 indicating that the customer's payment was accepted.

As another example, transaction software 22 may receive a communication from payment authorization system 50 indicating that the customer's credit limit would be exceeded.

As another example, transaction software 22 may receive a communication from payment authorization system 50 indicating that the customer's account has insufficient funds for a debit card transaction.

In step 88, transaction software 22 displays a message alerting the operator regarding the status of payment. if the payment was not accepted, operation continues to step 90. Otherwise, operation proceeds to step 100.

In step 90, transaction software 22 displays a menu of choices.

At this point, the customer may take various steps to try to complete payment. For example, the customer may try a different payment card. As another example, the customer may pay with cash money currency.

Alternatively, the customer may choose to contact the bank that provided the payment card that resulted in payment not being accepted to determine what the problem was and attempt to find a solution for completing payment.

In step 92, transaction software 22 records an operator selection to begin a video conferencing session with a representative of the financial institution 30 that denied payment.

In step 94, transaction software 22 begins a video conferencing session with the representative of the financial institution 30.

Transaction software 22 may begin the video conferencing session using contact information 26.

Alternatively, transaction software 22 may begin the video conferencing session using customer provided contact information.

During the video conferencing session, camera 80 captures images of the customer and sends the images to video conference software 32 for display. Similarly sound circuitry 82 captures customer audio and sends it to video conference software 32. Sound circuitry 82 also receives and plays audio from video conference software 32. In addition, the customer may an input device, such as the touch interface of touch screen 72, in order to send certain sensitive information to the representative that the customer does not want others in the vicinity to hear.

The representative may ask the customer for authenticating information, either through speech or messages, such as text or email messages, to the customer's mobile communication device 40 using communication software 34, or a combination of both.

In one example embodiment, the representative may ask the customer for name, date of birth, and other information stored in customer profiles 36.

In another example embodiment, the representative may send the customer a code, which the customer can access using mobile communication device 40, and ask that the customer enter the code into transaction system 20 in order to continue with the video conferencing session.

In another example embodiment, the representative may ask the customer to take a self-image using a camera of mobile communication device 40 and send it to the representative via email or text message.

For debit card transactions, customer entry of a PIN may also serve to authenticate the customer, alone or in combination with other authentication procedures.

In step 96, transaction software 22 ends the video conferencing session with the financial institution. Operation returns to step 90 to enter another choice.

If the problem with the first attempt to pay was a credit limit, the outcome of the video conferencing session may have been an increase in the customer's credit limit by the representative.

In step 98, transaction software 22 records an operator selection to try payment again. Operation returns to step 80.

In step 100, transaction software 22 finalizes the transaction to reflect that payment was successfully made and prints a receipt using printer 76.

Although the invention has been described with particular reference to certain preferred embodiments thereof, variations and modifications of the present invention can be effected within the spirit and scope of the following claims.

What is claimed is:

1. A method of completing a purchase transaction comprising:
attempting by a transaction terminal to complete a payment through a payment authorization system;
receiving by the transaction terminal a notification from the payment authorization system of a problem resulting in the payment not being completed;
establishing by the transaction terminal a video conferencing session with the representative of a financial system of a financial institution associated with the customer to correct the problem; and
completing by the transaction terminal the payment through the payment authorization system in accordance with an outcome of the video conferencing session.

2. The method of claim 1, wherein attempting comprises sending payment information to the payment authorization system.

3. The method of claim 2, wherein the payment information is from a customer payment card.

4. The method of claim 3, wherein the payment information includes a personal identification number (PIN).

5. The method of claim 1, wherein the problem comprises a customer credit limit is exceeded for a credit card payment.

6. The method of claim 1, wherein the problem comprises a customer account has insufficient funds for a debit card payment.

7. The method of claim 1, wherein establishing comprises establishing the video conferencing session using contact information obtained by the transaction terminal.

8. The method of claim 7, wherein establishing comprises establishing the video conferencing session using contact information obtained by the transaction terminal from the customer.

9. The method of claim 1, wherein establishing comprises capturing authentication information from the customer.

10. The method of claim 9, wherein the authentication information comprises a customer code from the financial system received by a customer mobile communication device.

11. A method of completing a purchase transaction comprising:
sending by a transaction terminal payment information from a customer payment card to a payment authorization system;
receiving by the transaction terminal a notification from the payment authorization system of a problem resulting in the payment not being completed;
initiating by the transaction terminal a video conferencing session with the representative of a financial system of a financial institution associated with the customer to correct the problem using contact information obtained from a customer;
capturing by the transaction terminal authentication information from the customer;
sending the authentication information to the financial intuition; and
resending by the transaction terminal the payment information to the payment authorization system in accordance with an outcome of the video conferencing session to complete payment.

12. A method of completing a purchase transaction comprising:
sending by a transaction terminal payment information from a customer payment card to a payment authorization system;
receiving by the transaction terminal a notification from the payment authorization system of a problem resulting in the payment not being completed;
initiating by the transaction terminal a video conferencing session with the representative of a financial institution associated with the customer to correct the problem using contact information obtained from a customer;
recording by the transaction terminal a customer code received from the financial intuition and displayed by a customer mobile communication device; and
resending by the transaction terminal the payment information to the payment authorization system in accordance with an outcome of the video conferencing session to complete payment.
